(19) United States
(12) Patent Application Publication
(10) Pub. No.: US 2011/0243414 A1
(43) Pub. Date: Oct. 6, 2011

(54) OPTICAL TOMOGRAPHIC INFORMATION GENERATING DEVICE, LIGHT INTENSITY DISTRIBUTION COMPUTING METHOD, AND COMPUTER-READABLE MEDIUM

(75) Inventors: Hiroaki YAMAMOTO, Ashigarakami-gun (JP); Shinpei OKAWA, Tokyo (JP); Yukio YAMADA, Tokyo (JP)

(73) Assignee: FUJIFILM CORPORATION, Tokyo (JP)

(21) Appl. No.: 13/016,840

(22) Filed: Jan. 28, 2011

(30) Foreign Application Priority Data
Mar. 31, 2010 (JP) 2010-084380

(51) Int. Cl. G06K 9/00

(52) U.S. Cl. 382/131

(57) ABSTRACT

An optical tomographic information generating device which generates optical tomographic information of a subject by using an updated value has: a Jacobian matrix computing unit that computes a Jacobian matrix that expresses a proportion of change in a light intensity distribution with respect to change in an optical characteristic value of the subject; a singular value decomposing unit that acquires a diagonal matrix of the Jacobian matrix; a unit diagonal matrix acquiring unit that acquires a unit diagonal matrix in which diagonal components that are less than or equal to a threshold value are replaced by 0; and a successive approximation unit that carries out approximation by carrying out substitution, that uses the unit diagonal matrix, with respect to a difference between an actually measured value and the computed value that appears in a successive approximation formula of ART (Algebraic Reconstruction Technique), and acquires the updated value.

### CROSS-REFERENCE TO RELATED APPLICATION

This application claims priority under 35 USC 119 from Japanese Patent Application No. 2010-084380 filed on Mar. 31, 2010, the disclosure of which is incorporated by reference herein.

### BACKGROUND OF THE INVENTION

1. Field of the Invention

The present invention relates to the technique of tomography using light, and in particular, relates to an optical tomographic information generating device that illuminates excitation light and is adapted to acquire an optical tomographic image by using distribution information of a light-emitting body that emits light due to this excitation light, and to a light intensity distribution computing method, and to a computer readable medium that stores a light intensity distribution computing program.

2. Description of the Related Art

X-ray CT (Computed Tomography) that uses X-rays, ultrasonic CT that uses ultrasonic waves, NMR-CT that applies nuclear magnetic resonance, proton CT that uses a particle beam of protons or the like, and the like are methods of acquiring a tomographic image of a living body or the like. Further, it is known that living bodies are light-transmissive, and optical CT that uses light for tomographic images of small animals has been proposed (see, for example, Japanese Patent Application Laid-Open (JP-A) Nos. 11-173976, 11-337476).

Light that is illuminated onto a living body scatters within the living body, and the scattered light exits from the periphery of the living body. Optical CT detects light that is irregularly reflected within a living body and exits from the periphery of the living body, and acquires electric signals, and carries out image reconstruction from information obtained by subjecting the respective electric signals to predetermined signal (image signal) processing, thereby obtaining a tomographic image of the living body.

In the field of pathological experimentation, in a case in which a medicament, that contains a phosphor that emits light due to light of a predetermined wavelength, or the like is administered to a living body, and the movement, distribution, accumulation process at the time of accumulating at a specific region, and the like of the medicament within the living body are observed, optical CT (hereinafter called fluorescence CT) may be used. Namely, excitation light with respect to the phosphor is illuminated onto the living body, the emitted light (fluorescence) that exits from the living body in accordance with this excitation light is detected, and a two-dimensional tomographic image or three-dimensional tomographic image of the living body is reconstructed. Due thereto, information such as the position, the amount and the like of the phosphor and the reagent or cells or the like containing the phosphor is obtained from the tomographic image.

In fluorescence CT as well, excitation light is illuminated onto one point of the surface of the living body, and the scattered fluorescence that exits from the living body due thereto is detected at multiple points. By repeating this while changing the illumination position of the excitation light, data of a number equal to the number of illumination points×the number of detection points is acquired. Relationships among these data, which relationships correspond to the distribution of the fluorescent substance, the scattering of light within the body, and the absorption characteristic, are established, and a tomographic image is reconstructed on the basis of these relationships.

In fluorescence CT, there has been proposed, in cases in which the density distribution of the phosphor is computed in order to carry out reconstruction of a tomographic image, carrying out inverse problem computation with respect to two light intensity distributions that are the excitation light intensity distribution and the fluorescence intensity distribution (see, for example, US Patent Application No. 2007/0286468 and S. R. Arridge, “Optical Tomography in Medical Imaging”, Inverse Problems 15 (1999) R41-93).

### SUMMARY OF THE INVENTION

The present invention has been made in view of the above circumstances and provides an optical tomographic information generating device, a light intensity distribution computing method, and to a computer readable medium that stores a light intensity distribution computing program.

According to an aspect of the present invention, there is provided an optical tomographic information generating device that, on the basis of a light diffusion equation, determines a computed value of an intensity distribution of light exiting from a subject, and, in accordance with a difference between the computed value and an actually measured value, carries out recomputation that uses ART (Algebraic Reconstruction Technique) and acquires an updated value of the computed value, and generates optical tomographic information of the subject by using the updated value, the device including: a Jacobian matrix computing unit that computes, from an optical characteristic value of the subject, a Jacobian matrix that expresses a proportion of change in the light intensity distribution with respect to change in the optical characteristic value; a singular value decomposing unit that singular-value-decomposes the Jacobian matrix, and acquires a diagonal matrix; a unit diagonal matrix acquiring unit that acquires a unit diagonal matrix in which diagonal components, that are less than or equal to a threshold value, of the diagonal matrix are replaced by 0; and a successive approximation unit that, in recomputation using the ART, carries out approximation by carrying out substitution, that uses the unit diagonal matrix, with respect to a difference between an actually measured value and the computed value that appears in a successive approximation formula of the ART, and acquires the updated value.

### BRIEF DESCRIPTION OF THE DRAWINGS

Preferred embodiments of the present invention will be described in detail based on the following figures, wherein:

FIG. 1 is a drawing showing the main external structure of an optical tomographic information generating device relating to a first exemplary embodiment;

FIG. 2 is a drawing showing the detailed structures of a measuring section and an image processing section relating to the first exemplary embodiment;

FIG. 3 is a functional block diagram for explaining inputted and outputted data and data processing of the image processing section relating to the first exemplary embodiment;

FIG. 4A is a schematic drawing showing propagation of excitation light within a subject, and

FIG. 4B is a schematic drawing showing propagation of fluorescence within the subject;

FIG. 5 is a graph showing examples of optical characteristics of the subject;

FIG. 6 is a flowchart showing the processes of a light intensity distribution computing method relating to the first exemplary embodiment;

FIG. 7 is a functional block diagram illustrating a more detailed structure of an updating processing section relating to the first exemplary embodiment;

FIG. 8 is an image obtained by imaging a mouse, to which antibodies have been administered, from the direction of the abdominal portion by a two-dimensional camera;

FIG. 9A is an example of an image reconstructed by the conventional ART method, and FIG. 9B is an example of a reconstructed image obtained by the optical tomographic information generating device relating to the first exemplary embodiment;

FIG. 10 is a drawing showing, as a characteristic curve, the relationship between the rank of a Jacobian matrix J and values of singular values in a diagonal matrix D;

FIGS. 11A through 11F are drawings showing results of verifying, by data of an actual mouse to which antibodies have been administered, the relationship between a threshold value and accuracy of a reconstructed image;

FIG. 12 is a block diagram showing main structures of a measuring section and an image processing section within an optical tomographic information generating device relating to a second exemplary embodiment;

FIG. 13 is a drawing for explaining relationships and the like of respective light-receiving heads relating to the second exemplary embodiment; and

FIG. 14 is a flowchart showing the processes of a light intensity distribution computing method relating to the second exemplary embodiment.

### DETAILED DESCRIPTION OF THE INVENTION

With inverse problem computation for obtaining light intensity distribution, as compared with direct problem computation, the computation load is great, the device structure tends to become large-scale, and a long time is needed for computation. There is also the approach of mitigating such problems by approximation computation, but it is often the case that approximation itself cannot be carried out accurately in a noise environment.

The present invention provides an optical tomographic information generating device that, in fluorescence tomography for example, can simplify the device structure, and, when computing a light intensity distribution, can reduce the computing processing load and shorten the processing time, and provides a light intensity distribution computing method and a computer readable medium that stores a light intensity distribution computing program.

In accordance with a first aspect of the present invention, there is provided an optical tomographic information generating device that, on the basis of a light diffusion equation, determines a computed value of an intensity distribution of light exiting from a subject, and, in accordance with a difference between the computed value and an actually measured value, carries out recomputation that uses ART (Algebraic Reconstruction Technique) and acquires an updated value of the computed value, and generates optical tomographic information of the subject by using the updated value, the device including: a Jacobian matrix computing unit that computes, from an optical characteristic value of the subject, a Jacobian matrix that expresses a proportion of change in the light intensity distribution with respect to change in the optical characteristic value; a singular value decomposing unit that singular-value-decomposes the Jacobian matrix, and acquires a diagonal matrix; a unit diagonal matrix acquiring unit that acquires a unit diagonal matrix in which diagonal components, that are less than or equal to a threshold value, of the diagonal matrix are replaced by 0; and a successive approximation unit that, in recomputation using the ART, carries out approximation by carrying out substitution, that uses the unit diagonal matrix, with respect to a difference between an actually measured value and the computed value that appears in a successive approximation formula of the ART, and acquires the updated value.

In accordance with a second aspect of the present invention, there is provided a light intensity distribution computing method that, on the basis of a light diffusion equation, determines a computed value of an intensity distribution of light exiting from a subject, and, in accordance with a difference between the computed value and an actually measured value, carries out recomputation that uses ART and updates the computed value, the method including: computing, from an optical characteristic value of the subject, a Jacobian matrix that expresses a proportion of change in the light intensity distribution with respect to change in the optical characteristic value; singular-value-decomposing the Jacobian matrix, and obtaining a diagonal matrix; acquiring a unit diagonal matrix in which diagonal components, that are less than or equal to a threshold value, of the diagonal matrix are replaced by 0; and in recomputation using the ART, carrying out approximation by carrying out substitution, that uses the unit diagonal matrix, with respect to a difference between an actually measured value and the computed value that appears in a successive approximation formula of the ART, and obtaining an updated value of the computed value.

In accordance with the present invention, the computing processing load at the time of computing a light intensity distribution can be reduced, and simplification of the device structure and shortening of the measuring time can be realized.

Exemplary embodiments of the present invention are described hereinafter with reference to the appended drawings. Here, a case using a fluorescence tomography device as an optical tomographic information generating device is described as an example.

### First Exemplary Embodiment

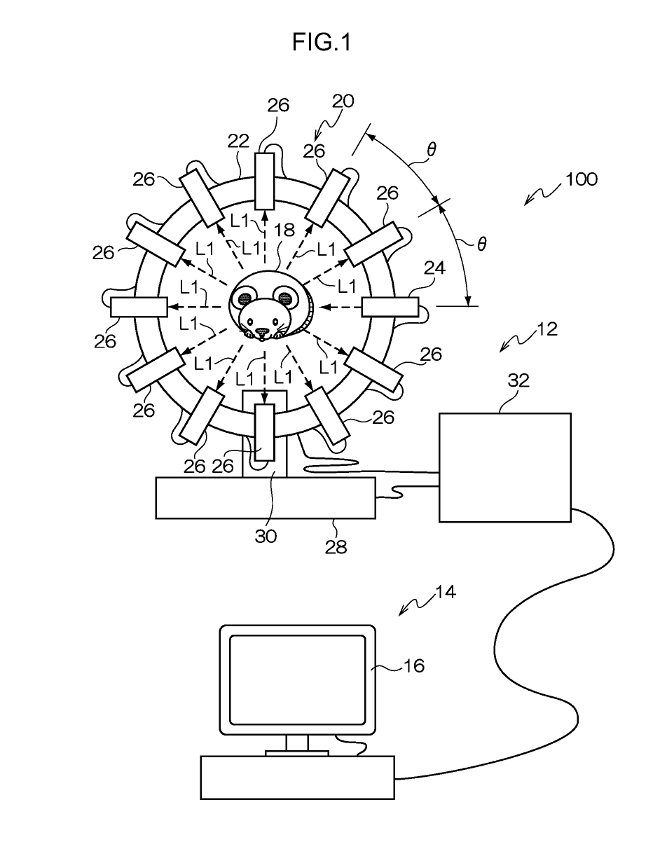

FIG. 1 is a drawing showing the main external structure of an optical tomographic information generating device 100 relating to a first exemplary embodiment of the present invention. The optical tomographic information generating device 100 includes a measuring section 12 and an image processing section 14.

The image processing section 14 carries out image processing (signal processing) that is based on electric signals outputted from the measuring section 12. A monitor 16 such as a CRT, an LCD or the like is provided as a display unit at the image processing section 14. An image based on the results of measurement of the measuring section 12 is displayed on the monitor 16.

At the optical tomographic information generating device 100, a living body such as a small animal (e.g., a nude mouse) or the like is a subject 18 that is the object of measurement, and an image (hereinafter called optical tomographic image) that is based on optical tomographic information obtained from the subject 18 is displayed on the monitor 16, and image data (optical tomographic information) of the displayed image is stored on any of various types of storage media.

The measuring section 12 has a measuring unit 20. The measuring unit 20 has a ring-shaped frame 22. The axially central portion of the frame 22 is a measurement position. At the measuring section 12, the subject 18 is disposed at the measurement position within the frame 22.

At the measuring unit 20, a light source head 24, that illuminates light of a predetermined wavelength toward the measurement position, and plural light-receiving heads 26, that detect light exiting from the living body as detected light L1 and output the detected light L1, are mounted to the frame 22 at predetermined angular intervals (so as to be set apart from one another at a predetermined angle θ). In the optical tomographic information generating device 100 that is applied to the present exemplary embodiment, as an example, eleven of the light-receiving heads 26 are arranged so as to be offset by 30° each time (θ=30°) from the light source head 24.

Due to this structure, at the measuring section 12, the detected lights L1 that exit from the subject 18 with respect to the light illuminated from the light source head 24, are received in parallel by the eleven light-receiving heads 26 respectively.

At the measuring section 12, the frame 22 is structured so as to mechanically rotate by a predetermined angle each time with respect to the axial center. Due thereto, at the measuring section 12, during measurement, light is illuminated from the light source head 24 toward plural points of the periphery of the subject 18, and the light-receiving heads 26 can receive the detected lights L1 at the respective positions. Here, as an example, the frame 22 rotates by angle θ (θ=30°) each time. The measuring section 12 is structured so as to illuminate light with respect to twelve points of the periphery of the subject 18, and detect the detected lights L1 at eleven places at each of the illumination points. The number of the light source head 24, the number of the light-receiving heads 26, the arrangement thereof, the amounts of movement (the amounts of rotation) of the light source head 24 and the light-receiving heads 26, and the like are not limited to these, and arbitrary numbers, arrangements, and amounts of movement (amounts of rotation) may be applied.

At the measuring section 12, a support 30 stands on a stand 28, and the frame 22 is rotatably supported with respect to the support 30. Further, the support 30 is supported so as to be able to move along the axial direction of the frame 22 (the direction perpendicular to the surface of the drawing of FIG. 1). Namely, the frame 22 is adapted to rotating, and is adapted to moving along the axial direction of the rotational axis thereof, and is adapted to measurement with respect to an arbitrary region of the subject 18 along the rotational axis direction of the frame 22. Due to this structure, a three-dimensional reconstructed image can be acquired.

Arbitrary structures may be used for the rotating mechanism and the moving mechanism of the frame 22. At the measuring section 12, the frame 22 is rotated, but the present invention is not limited to the same and may be structured such that the subject 18 that is disposed within the frame 22 is rotated. Or, the subject 18 and the frame 22 may respectively be rotated.

A control unit 32 is provided at the measuring section 12.

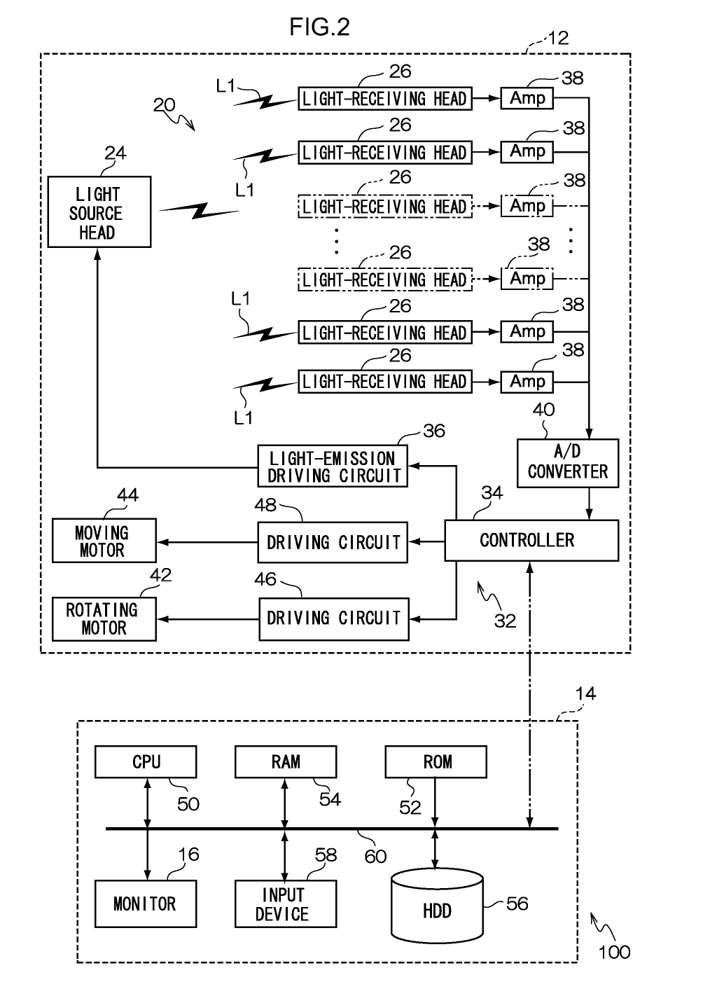

FIG. 2 is a drawing showing the detailed structures of the measuring section 12 and the image processing section 14. Note that structural elements that are the same as in FIG. 1 are denoted by the same reference numerals.

As shown in FIG. 2, the control unit 32 is equipped with a controller 34 that is structured to include a microcomputer. The control unit 32 has a light-emission driving circuit 36 that drives the light source head 24, amplifiers (Amp) 38 that amplify the electric signals that are outputted from the respective light-receiving heads 26, an A/D converter 40 that converts the electric signals outputted from the amplifiers 38 into digital signals, and the controller 34 that controls the emission of light by the light source head 24, the reception of the detected lights L1 at the respective light-receiving heads 26, and the generation of measurement data that expresses the intensities of the detected lights L1 that are received.

The measuring section 12 includes a rotating motor 42 that drives and rotates the frame 22 of the measuring unit 20, a moving motor 44 that moves the frame 22 in the axial direction, and respective driving circuits 46, 48 thereof. The driving circuits 46, 48 are connected to the controller 34.

At the image processing section 14, a computer of a general structure is formed in which a CPU 50, a ROM 52, a RAM 54, an HDD 56 that is a storage unit, an input device 58 such as a keyboard or a mouse or the like, the monitor 16, and the like are connected to a bus 60. Due thereto, the image processing section 14 is adapted to carrying out various types of control based on programs stored in the ROM 52 and the HDD 56 and programs stored in an unillustrated removable memory or the like, and to carrying out signal processing, image processing, and the like. Note that, in the present application, the ROM 52, the RAM 54, the HDD 56, and the unillustrated removable memory are generically and simply called memory 51.

The transmission and reception of control signals and the transmission and reception of data are carried out between the image processing device 14 and the control unit 32 of the measuring section 12. Note that an arbitrary communication interface may be used for this structure.

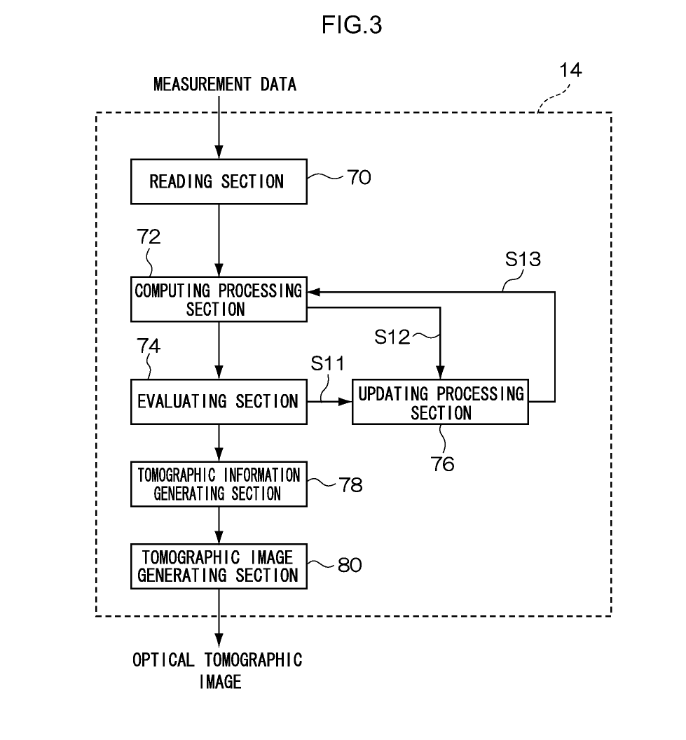

FIG. 3 is a functional block diagram for explaining inputted and outputted data and internal data processing of the image processing device 14.

As shown in FIG. 3, the image processing section 14 is equipped with a reading section 70. While measurement of the subject 18 at the measuring section 12 is controlled, the measurement data outputted from the measuring section 12 (the control unit 32) is read-in to the memory 51.

The image processing section 14 has a computing processing section 72, an evaluating section 74, an updating processing section 76, a tomographic information generating section 78, and a tomographic image generating section 80.

The computing processing section 72 computes the intensity distribution of fluorescence by direct problem computation using a light diffusion equation on the basis of optical characteristic values of the subject 18 that are set in advance and include the absorption coefficient distribution of a phosphor 62. The evaluating section 74 evaluates the difference between the computed intensity distribution of the fluorescence and the intensity distribution of the fluorescence obtained from the measurement data. The updating processing section 76 sets an absorption coefficient distribution and the like, that are based on the density distribution of the phosphor, from the intensity distribution of the fluorescence so as to decrease the difference obtained from the results of evaluation of the evaluating section 74. When updating of the absorption coefficient distribution and the like that are based on the density distribution of the phosphor is carried out at the updating processing section 76, the computing processing section 72 carries out computation of the fluorescence intensity distribution that is based on the absorption coefficient distribution and the like that are based on the updated density distribution of the phosphor.

When updating and evaluating of the intensity distribution of the fluorescence are repeated in this way, and, for example, the difference between the computed intensity distribution of the fluorescence and the measurement data is evaluated to be within an allowable range, the tomographic information generating section 78 generates an intensity distribution of the fluorescence that is optical tomographic information, from the absorption coefficient distribution and the like that are based on the density distribution of the phosphor at this time. The tomographic image generating section 80 generates an optical tomographic image on the basis of this optical tomographic information.

In this way, the image processing section 14 carries out predetermined data processing on the measurement data read-in from the measuring section 12. Thereafter, by carrying out image processing that is based on these processing results, the image processing section 14 reconstructs an optical tomographic image of the subject 18 that is based on the measurement data.

The method of computing the light intensity distribution that is used at the optical tomographic information generating device 100 relating to the present exemplary embodiment is theoretically described with reference to both the drawings and numerical expressions.

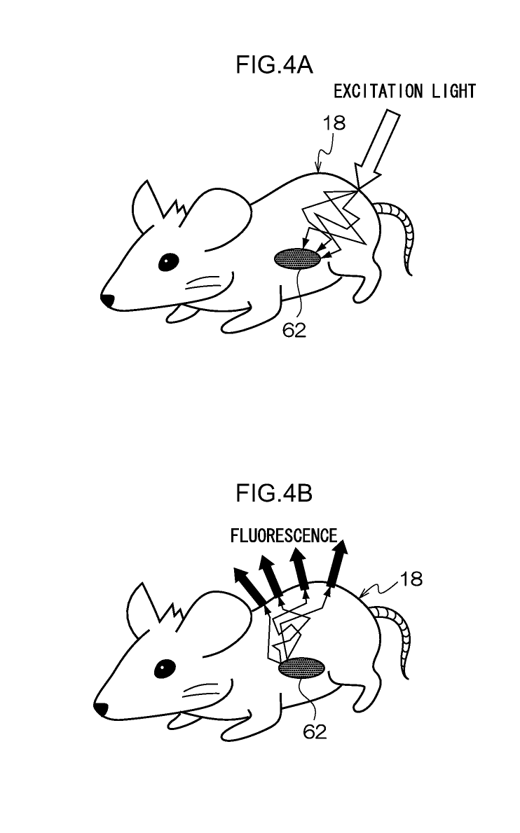

In the present exemplary embodiment, as shown in FIG. 4A and FIG. 4B, light that is emitted from the light source head 24 of the optical tomographic information generating device 100 is used as excitation light. A substance or a medicament that includes the phosphor 62, that emits fluorescence due to this excitation light being illuminated, is administered to the subject 18. The optical tomographic information generating device 100 reconstructs an image, that includes the distribution of the phosphor 62, as a tomographic image of the subject 18, and the distribution of the phosphor 62 with respect to the various internal organs within the subject 18 can be visually confirmed.

Concretely, as shown in FIG. 4A, when excitation light is illuminated onto the subject 18, the excitation light reaches the phosphor 62 while scattering within the subject 18. Due thereto, the phosphor 62 within the subject 18 emits light. Further, as shown in FIG. 4B, the fluorescence generated from the phosphor 62 exits from the subject 18 while repeating scattering within the subject 18. At this time, the excitation light also exits together with the fluorescence, but because the light-receiving head 26 has an unillustrated excitation light cutting filter at the front end thereof, only the fluorescence that exits from the subject 18 is the detected light, and the intensity of this detected light (hereinafter called fluorescence) is detected. The optical tomographic information generating device 100 obtains the distribution (density distribution) of the phosphor 62 within the subject 18 from the light intensity distribution of this detected light.

In the case of illuminating light such as excitation light or the like onto the subject 18, the region that is in the vicinity of the illumination position is an anisotropic scattering region in which the refractive index with respect to light differs in accordance with the direction, and the like. However, when the light moves away from the illumination position by a predetermined distance or more within the subject 18, there becomes an isotropic scattering region.

The light that scatters within the subject 18 is considered to be particles that transport energy, and therefore, the distribution of the light intensity can be expressed by using a light transport equation that is an energy conservation formula of light intensity. However, solving the light transport equation is difficult in actuality.

In the subject 18, the anisotropic scattering region is generally around several mm. Therefore, in a subject 18 of a size of several cm or more, the interior of the body of the subject can substantially be considered to be an isotropic scattering region. Namely, the scattering of light at the subject 18 can be approximated as isotropic scattering.

For these reasons, the distribution of the light intensity is obtained by using a light diffusion equation. The light diffusion equation is expressed by following formula (1). Here, Φ(r,t) represents the light density within the subject 18, D(r) represents the diffusion coefficient distribution, μa(r) represents the absorption coefficient distribution, q(r,t) represents the light density of the light source, r represents the coordinate position within the subject 18, and t represents time.

$$\begin{matrix}[ Expression 1 ] & \\ \{ \frac{1}{c} \frac{\partial φ}{\partial t} - ∇ \cdot D ( r ) ∇ + {μ}_{a} ( r ) \} Φ ( r , t ) = - q ( r , t ) & ( 1 )\end{matrix}$$

Here, if the light is light that is continuous over time, the light diffusion equation can be expressed by following formula (2).

[Expression 2]

{∇·D(r)∇−μₐ(r)}Φ(r)=−q(r) (2)

In a case in which the diffusion coefficient distribution D(r) and the absorption coefficient distribution μa(r) that are optical characteristic values are already known, computation as a direct problem can be carried out in a case in which the light intensity distribution that exits from the subject 18 is determined by using this light diffusion equation (2). However, the light intensity distribution is already known, and determining, from this, the diffusion coefficient distribution D(r) and the absorption coefficient distribution μa(r), that are optical characteristic values of the subject 18, by using a light diffusion equation is inverse problem computation.

Here, the diffusion coefficient distribution D(r) and the absorption coefficient distribution μa(r) at the subject 18 differ in accordance with the wavelength of the light. Therefore, given that the diffusion coefficient distribution with respect to the wavelength of the excitation light is Dₛ(r), the absorption coefficient distribution is pas(r), and the light density of the light source is qs(r), the light diffusion equation with respect to the excitation light is expressed by following formula (3). On the other hand, given that the diffusion coefficient distribution with respect to the wavelength of the fluorescence is Dm(r), the absorption coefficient distribution is μam(r), and the light source of the fluorescence is qm(r), the light diffusion equation with respect to the fluorescence is expressed by following formula (4). Further, the light source qm(r) of the fluorescence can be expressed by qm=γ·ε·N(r)·Φs(r), by using the optical density Φs(r) within the subject 18, the quantum efficiency γ of the phosphor 62, the molar absorption coefficient ε, and the density distribution N(r). Accordingly, formula (4) is replaced by following formula (5).

[Expression 3]

{∇·Dₛ(r)∇−μₐₛ(r)}Φₛ(r)=−qₛ(r) (3)

{∇·Dₘ(r)∇−μₐₘ(r)}Φₘ(r)=−qₘ(r) (4)

{∇·Dₘ(r)∇−μₐₘ(r)}Φₘ(r)=−γεN(r)Φₛ(r) (5)

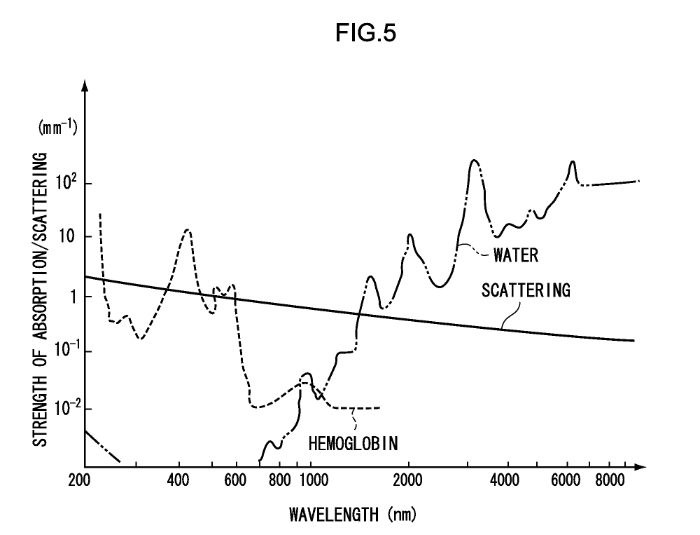

As shown by the dashed line in FIG. 5, hemoglobin within the subject 18 has strong absorption with respect to light of wavelengths of around 700 nm or less. Further, as shown by the two-dot chain line in FIG. 5, water within the subject 18 has strong absorption with respect to light whose wavelength is about 1 μm or more. In other words, absorption at the subject 18 is weak in the wavelength region of 700 nm to 1 μm. This band is called the so-called optical window. Accordingly, the subject 18 corresponds to the optical window. In this wavelength region, the absorption coefficient distribution μa of the subject 18 is a range of from 0.002 mm⁻¹ to 0.1 mm⁻¹.

The scattering coefficient (strength of scattering, shown by the solid line in FIG. 5) within the subject 18 becomes small as the wavelength becomes long, and the change therein is gradual. In the wavelength region of 700 nm to 1 μm that is the optical window, the strength of the scattering can be considered to be substantially constant, regardless of the wavelength.

Therefore, in the optical tomographic information generating device 100 relating to the present exemplary embodiment, infrared rays (near infrared rays) of wavelengths of 700 nm to 1 μm, that correspond to the optical window at the living body (the subject 18) are used as the excitation light that is emitted from the light source head 24. Due thereto, the absorption coefficient μa and the scattering coefficient (diffusion coefficient D), that are optical characteristics at the subject 18, can be made to be substantially regular values (already known values), and formula (3) and formula (5) can be simplified by Dₛ(r)=Dₘ(r)=D(r), μₐₛ(r)=μₐ(r)+ε·N(r), μₐₘ(r)=μₐ(r). Here, ε represents the molar absorption coefficient, N(r) represents the density distribution of the phosphor 62, and ε·N(r) represents the degree of absorption of the excitation light by the phosphor 62. Accordingly, formula (3) is replaced by following formula (6), and formula (5) is replaced by following formula (7).

[Expression 4]

{∇·D(r)∇−μₐ(r)−εN(r)}Φₛ(r)=−qₛ(r) (6)

{∇·D(r)∇−μₐ(r)}Φₘ(r)=−γεN(r)Φₛ(r) (7)

Further, a substance or medicament, that contains the phosphor 62 that emits near infrared beams as excitation light, is administered to the subject 18 whose tomographic image is observed in the present exemplary embodiment. At this time, as shown by above formula (7), the intensity of the fluorescence in a case in which the phosphor 62 is the light source is based on the intensity Φₛ(r) of the excitation light, i.e., is a function of Φₛ(r). This is already known if the diffusion coefficient distribution and the absorption coefficient distribution are set in advance. Because the light intensity qₛ(r) of the light source also is already known, the light intensity Φₛ(r) within the subject 18 can be determined as a direct problem by a numerical analysis method such as the finite element method or the like.

Accordingly, the fluorescence intensity is measured at the measuring section 12, the fluorescence intensity distribution Φₘ(r) is determined on the basis of this measurement data, and the density distribution N(r) of the phosphor 62 within the subject 18 can be determined by one (one system of) inverse problem computation. There is no need to measure the excitation light intensity at the measuring section 12.

By synthesizing the obtained density distribution N(r) at position r of the phosphor 62 with the tomographic image at position r of the subject 18, the density distribution of the phosphor 62 within the subject 18 can be visually confirmed in the optical tomographic image.

Concretely what kind of computing processing is carried out at the optical tomographic information generating device 100 relating to the present exemplary embodiment is described next on the basis of the above-described theory.

At the optical tomographic information generating device 100, when the subject 18 is disposed at the measuring unit 20 of the measuring section 12, near infrared light of a preset wavelength is illuminated from the light source head 24 onto the subject 18 as excitation light. This excitation light propagates (passes) through the interior of the subject 18 while diffusing.

Here, when the phosphor 62 has been administered to the subject 18, the excitation light is illuminated onto the phosphor 62, and due thereto, the phosphor 62 emits light. This fluorescence propagates through the interior of the subject 18 while diffusing, and exits from the subject 18 toward the periphery thereof.

At the measuring unit 20, the light-receiving heads 26 are arranged at a predetermined angular interval so as to surround the subject 18. At the measuring section 12, the fluorescence that exits from the subject 18 is received at the respective light-receiving heads 26 as detected light.

Further, at the measuring section 12, due to the frame 22 being rotated, the illumination position of the excitation light toward the subject 18 and the detection positions of the fluorescence that exits from the subject 18 are changed relatively, and illumination of the excitation light and receiving of the detected light are repeated. Due thereto, measurement data of the intensity of the fluorescence that corresponds to the illuminated excitation light is obtained along the periphery of the subject 18.

At the image processing section 14 of the optical tomographic information generating device 100, the density distribution N(r) of the phosphor 62 is computed on the basis of this measurement data.

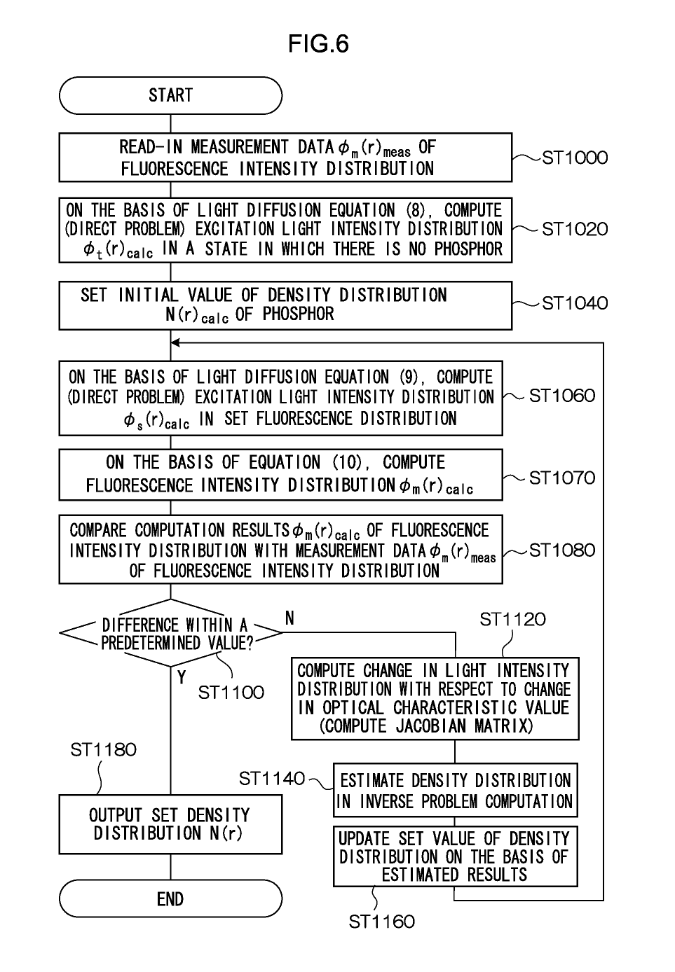

FIG. 6 is a flowchart showing the order of processings of density distribution computation of the phosphor 62 that the image processing section 14 carries out. As described above, computing the density distribution of the phosphor corresponds to computing the fluorescence intensity distribution. Therefore, this diagram can be said to show the processes of the light intensity distribution computing method relating to the present exemplary embodiment.

At the image processing section 14, near infrared rays of a wavelength that is set in advance on the basis of the optical characteristics of the subject 18 are used as the excitation light. Therefore, values of the absorption coefficient distribution μₐ(r) and the diffusion coefficient distribution D(r) are set in advance and stored. The absorption coefficient distribution μₐ(r) and the diffusion coefficient distribution D(r) may be values that are inputted appropriately in accordance with individual differences between the subjects 18.

In this flowchart, in step (hereinafter abbreviated as ST) 1000, actually measured values obtained by the plural light-receiving heads 26 of the measuring section 12, i.e., fluorescence intensity distribution Φ_{w}(r)ₘₑₐₛ that exits from the subject 18, are read-in to the memory 51.

In step ST1020, the absorption coefficient distribution μₐ(r) and the diffusion coefficient distribution D(r) that are set in advance are used, and excitation light intensity distribution Φₜ(r)_{calc} in a case in which a phosphor does not exist within the subject 18, i.e., in a case in which absorption of the excitation light by a phosphor does not occur, is computed in accordance with following light diffusion equation (8).

[Expression 5]

{∇·D(r)∇−μₐ(r)}Φₜ(r)_{calc}=−qₛ(r) (8)

In ST1040, the initial value of the density distribution N(r)_{calc} of the phosphor 62 is set. In ST1060, by using the density distribution N(r)_{calc} of the phosphor that was set in ST1040, and the absorption coefficient distribution μₐ(r) and the diffusion coefficient distribution D(r) that have been set in advance, excitation light intensity distribution Φₛ(r)_{calc} is computed in accordance with following light diffusion equation (9) that appropriately corrects above-described formula (6).

[Expression 6]

{∇·D(r)∇−μₐ(r)−εN(r)_{calc}}Φₛ(r)_{calc}=−qₛ(r) (9)

In ST1070, as shown in following formula (10), by subtracting the excitation light intensity distribution Φₛ(r)_{calc}, in the case in which absorption of excitation light by the phosphor arises, from the excitation light intensity distribution Φₜ(r)_{calc}, in the case in which absorption of excitation light by the phosphor does not arise, and multiplying this difference by coefficient γ that converts excitation light into fluorescence, computed fluorescence intensity distribution Φ_{w}(r)_{calc}, that is an estimated value of the fluorescence intensity exiting from the subject 18, is computed.

[Expression 7]

Φₘ(r)_{calc}=γ(Φₜ(r)_{calc}−Φₛ(r)_{calc}) (10)

In the computation of the excitation light intensity distribution Φₜ(r)_{calc} in ST1020 and the computation of the excitation light intensity distribution Φₘ(r)_{calc} in ST1060, the light diffusion equation that is a mathematical model can be computed relatively easily as known direct problem computation that uses a numerical analysis method such as the finite element method or the like.

In ST1080, the fluorescence intensity distribution Φₘ(r)ₘₑₐₛ that is based on the measurement data and the fluorescence intensity distribution Φₘ(r)_{calc} that is based on computational results are compared. In ST1100, it is judged whether or not the difference between the fluorescence intensity distribution Φₘ(r)ₘₑₐₛ and the fluorescence intensity distribution Φₘ(r)_{calc} is within an allowable range, and specifically, whether or not the difference is within a predetermined value that is set in advance.

In a case in which it is judged in ST1080 that the difference between the fluorescence intensity distribution Φₘ(r)ₘₑₐₛ and the fluorescence intensity distribution ₘ(r)_{calc} is not within the predetermined value, the judgment in ST1100 is negative, and the routine moves on to ST1120.

In ST1120, change in the light intensity distribution with respect to change in an optical characteristic value of the subject 18 is computed by a known method using a Jacobian matrix.

In ST1140, by applying an optimization method that is described hereinafter to the inverse problem expressed by following light diffusion equation (11), an estimated value N(r)ₑₛₜ of the density distribution of the phosphor 62 is determined.

[Expression 8]

{∇·D(r)∇−μₐ(r)}Φₘ(r)_{calc}=−γεN(r)_{calc}Φₛ(r)_{calc} (11)

In further detail, in ST1140, first, the error (e.g., square error y) between the fluorescence intensity distribution Φₘ(r)ₘₑₐₛ and the fluorescence intensity distribution Φₘ(r)_{calc} is evaluated. Namely, the square error y is obtained from following formula (12), and this square error y is evaluated.

[Expression 9]

y=∥Φₘ(r)ₘₑₐₛ−Φₘ(r)_{calc}∥² (12)

Next, in this ST1140, absorption εN of the fluorescence at the phosphor 62 that makes this square error y a minimum, i.e., density distribution N(r)ₑₛₜ of the phosphor 62, is estimated by the optimization method that is described hereinafter.

Although the estimated value N(r)ₑₛₜ of the density distribution is determined in this way, this is merely the determination of an estimated value with respect to N(r)_{calc} of above formula (11). In ST1160, N(r)_{calc} is updated by this estimated value N(r)ₑₛₜ of the density distribution, and the routine returns to ST1060.

The image processing section 14 repeatedly carries out the processings from ST1060 through ST1160. Due thereto, it is judged that the difference between the fluorescence intensity distribution Φₘ(r)ₘₑₐₛ and the fluorescence intensity distribution Φₘ(r)_{calc} is within the predetermined value, the judgment in ST1100 is affirmative (YES), and the routine proceeds to ST1180. In ST1180, the density distribution N(r)_{calc} that is ultimately set at this time is outputted as the density distribution N(r) obtained from the measurement data.

Here, after the fluorescence intensity distribution Φₘ(r)ₘₑₐₛ that is based on the measurement data is acquired, the initial value of the density distribution N(r)_{calc} of the phosphor 62 is set. However, the order of processings is not limited to the same. The fluorescence intensity distribution Φₘ(r)ₘₑₐₛ may be acquired after the initial value of the density distribution N(r)_{calc} of the phosphor 62 is set. With regard to the other processes as well, the order of the steps may be changed appropriately within a range that does not deviate from the object of this flowchart.

The present invention employs the ART (Algebraic Reconstruction Technique) as the optimization method for the inverse problem used in ST1140. However, with the ART, although convergence is fast, the resistance to noise (noise resistance) is low. Thus, the present inventors discovered an improved ART that is set forth hereinafter. Note that noise resistance is the property that computation can be converged within a predetermined time even in an environment in which there is much noise, or is the property that computational accuracy of a predetermined level or more can be maintained even in an environment in which there is much noise.

To describe this concretely together with numerical expressions, in order to solve the above-described inverse problem, the square error y in formula (12) must be made to be a minimum. Accordingly, in order to carry out this calculation, first, following formula (13) is obtained when formula (12) is simplified (Born approximated) by differentiation by N.

[Expression 10]

Δy=JΔx (13)

Here, Δx is a minute change in εN, and concretely, expresses the updated value of εN because repeated computation (an iterative method) that is the ART is used in the present exemplary embodiment. Jacobian matrix J expresses the proportion of the change in the light intensity distribution with respect to the change in the optical characteristic value. The light intensity distribution is expressed as a function of the coordinate position of the light source and the coordinate position of the detection point.

Because Δx is the solution to be determined in formula (13), when formula (13) is rewritten with respect to Δx, following formula (14) is obtained.

[Expression 11]

Δx=J⁻¹Δy (14)

In principle, computation should be able to proceed by using this formula (14), but, in actuality, the following problem arises when carrying out calculation on a computer by using formula (14) as is. Namely, in cases in which an extremely small component exists within the Jacobian matrix J, this component appears as a reciprocal in the inverse matrix J⁻¹. Therefore, in cases in which this component includes a small error such as noise, the error is magnified and greatly adversely affects the computational accuracy. This is the reason why the ART has poor noise resistance.

In the present application, first, the Jacobian matrix J is decomposed by using singular value decomposition that is one method of matrix decomposition, and following formula (15) is obtained.

[Expression 12]

J=UDV^{T} (15)

Here, D is a diagonal matrix of m×n rows whose diagonal components are the singular values of the Jacobian matrix, U is an orthonormal matrix of m×m rows, and V^{T} is a transposed matrix of n×n rows. V^{T} is the transposed matrix of V. There is the relationship U^{T}U=V^{T}V=I (unit matrix) between U and V.

Formula (15) becomes following formula (16) when rewritten into a form that can determine J⁻¹, in order to be able to substitute the formula into formula (14).

[Expression 13]

J⁻¹=VD⁻¹U^{T} (16)

Further, a new unit diagonal matrix H that is separate from the diagonal matrix D is introduced, and diagonal components whose singular values in D are less than or equal to threshold value αth are specified, and components of the same positions in H are replaced by 0 (components whose singular values are greater than the threshold value αth are maintained at 1). By using H, substitution of Δy, that is expressed by following formula (17) is carried out with respect to formula (14). In this substitution, because the components that are replaced with 0 are only the components that are less than or equal to the threshold value αth, it is expected that there is no great change in the magnitude (absolute value) of Δy overall.

[Expression 14]

Δy→UHU^{T}Δy (17)

Then, following formula (18) is obtained from above formula (14), formula (16), and formula (17).

[Expression 15]

Δx=VD⁻¹U^{T}UHU^{T}Δy=VD⁻¹HU^{T}Δy (18)

The D⁻¹H portion at the right side of formula (18) is a product with 0 for components of small values, and, for other diagonal components, the value of D⁻¹ is maintained as is. Namely, in accordance with the improved ART relating to the present application, computation of a phosphor density distribution can be carried out while reducing the effects of noise.

Because the ART is used in the present invention, concretely, the successive approximation formula of the ART of following formula (19) is computed instead of formula (18). Accordingly, the substitution of Δy using formula (17) is carried out with respect to formula (19). Here, λ is called a relaxation factor, and is a parameter that is used in computation in order to control the convergence of the solution.

$$\begin{matrix}[ Expression 16 ] & \\ Δ {x}^{( j + 1 )} = Δ {x}^{( j )} + λ \frac{[ Δ {y}^{( j )} - {J}^{( j )} Δ x ]}{{‖ {J}^{( j )} ‖}^{2}} {J}^{{( j )}^{T}} & ( 19 )\end{matrix}$$

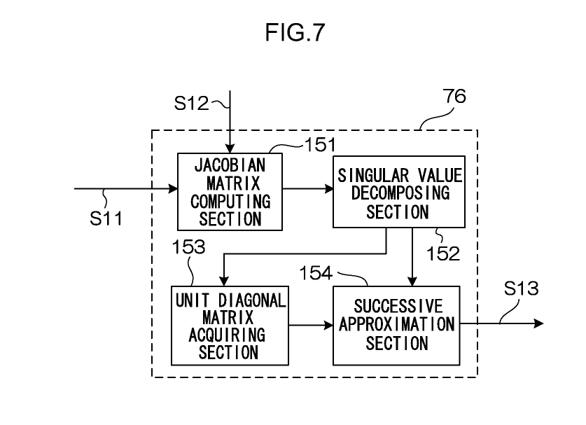

FIG. 7 is a functional block drawing showing the more detailed structure of the updating processing section 76 relating to the present exemplary embodiment that realizes the above-described computation. The updating processing section 76 has a Jacobian matrix computing section 151, a singular value decomposing section 152, a unit diagonal matrix acquiring section 153, and a successive approximation section 154.

In a case in which evaluation result signal S11, that is outputted from the evaluating section 74 shown in FIG. 3, is negative (NO), the Jacobian matrix computing section 151 determines the Jacobian matrix J from data signal S12 that is outputted from the computing processing section 72 shown in FIG. 3, and outputs the Jacobian matrix J to the singular value decomposing section 152. The data signal S12 includes an optical characteristic value of the subject 18, and the coordinate position of the light source head 24 and position information of the light-receiving heads 26 shown in FIG. 1 and FIG. 2. On the basis of the data signal S12, the Jacobian matrix computing section 151 determines the Jacobian matrix J in above formula (13), and more concretely, the Jacobian matrix in above formula (19).

In accordance with above formula (15), the singular value decomposing section 152 singular-value-decomposes the Jacobian matrix J that was determined by the Jacobian matrix computing section 151, and outputs the obtained diagonal matrix D to the unit diagonal matrix acquiring section 153, and outputs the orthonormal matrix U and the transposed matrix VT, that has been similarly obtained, to the successive approximation section 154.

On the basis of the diagonal matrix D outputted from the singular value decomposing section 152, the unit diagonal matrix acquiring section 153 determines the unit diagonal matrix H in accordance with the method of the present application that has been described above, and outputs the unit diagonal matrix H to the successive approximation section 154.

By using the orthonormal matrix U and the transposed matrix V^{T} outputted from the singular value decomposing section 152 and the unit diagonal matrix H outputted from the unit diagonal matrix acquiring section 153, the successive approximation section 154 computes the successive approximation formula of above formula (19), and determines Δx that is the updated value of εN, and outputs it to the computing processing section 72 shown in FIG. 3 (signal S13).

Operations exhibited by the optical tomographic information generating device 100 relating to the present exemplary embodiment are described next while introducing actual examples.

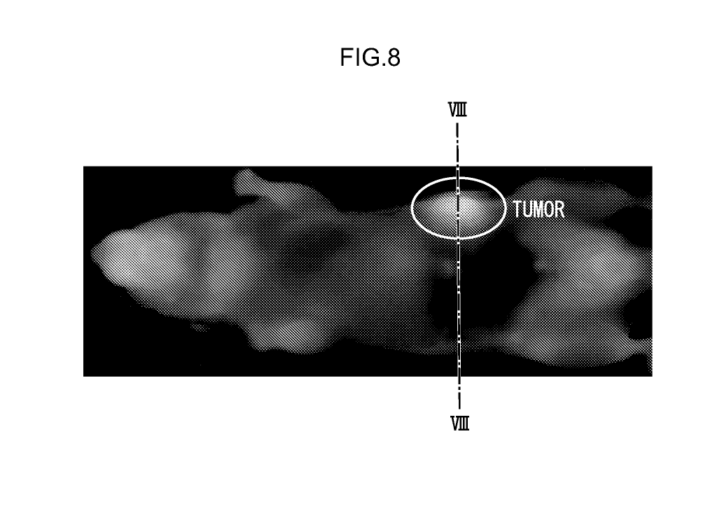

FIG. 8 is an image that is obtained by imaging, from the direction of the abdominal portion and by a two-dimensional camera, a nude mouse that actually has a tumor and to which antibodies have been administered. From this image, it can be confirmed that a tumor exists on the right abdomen portion of the mouse. Note that experiments on animals in the present application has been carried out in accordance with the Animal Ethics Rules and the Animal Experimentation Regulations of the Safety Evaluation Center internal to Fujifilm Corporation who is the applicant of the present application.

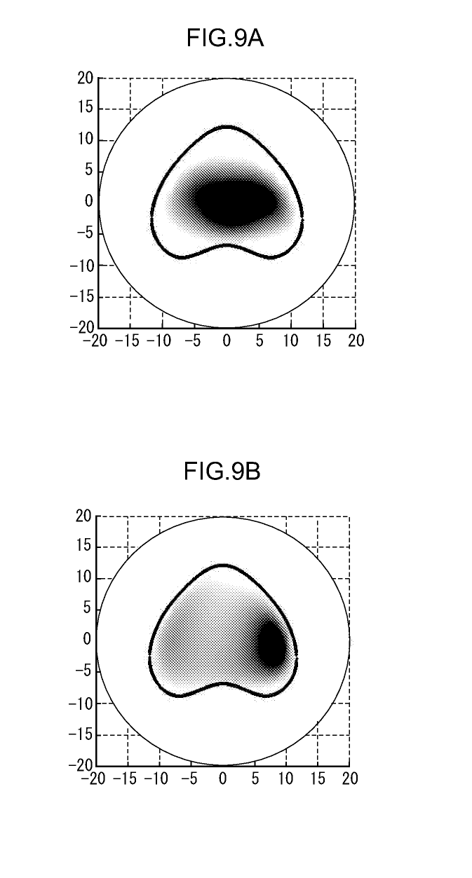

FIG. 9B is an example of a reconstructed image obtained from this mouse to which antibodies have been administered, by using the optical tomographic information generating device 100. When compared with the image reconstructed by the conventional ART that is shown in FIG. 9A, the existence of a tumor within the body of the mouse cannot be discerned by the conventional ART, but in the reconstructed image obtained by the optical tomographic information generating device 100 relating to the present exemplary embodiment, it can be understood that offset of the density distribution to the right abdominal portion of the mouse, i.e., the shadow of a tumor, is discerned.

As described above, in accordance with the optical tomographic information generating device 100 relating to the first exemplary embodiment of the present invention, the intensity of the fluorescence, that exits from the subject (living body) onto which excitation light has been illuminated, is detected, and measurement data of the intensity of the fluorescence (fluorescence intensity) is acquired. The respective distributions of the scattering coefficient and the absorption coefficient, that are optical characteristic values of the subject, are set in advance, and an absorption coefficient distribution of the phosphor, that is based on the density distribution of the phosphor, is provisionally set, and the intensity of the fluorescence is acquired from a mathematical model. The intensity of the fluorescence acquired from this mathematical model, and the intensity of the fluorescence acquired as measurement data, are compared, and evaluation of the difference is carried out. At this time, if the difference is greater than a predetermined level, by carrying out inverse problem computation, the absorption coefficient distribution is estimated so as to decrease the difference. By iterating the processing that compares the measurement data and the intensity of the fluorescence that is based on the estimated absorption coefficient distribution, an absorption coefficient distribution that is based on the density distribution of the phosphor is determined. From the absorption coefficient distribution that is based on the density distribution of the phosphor and is obtained in this way, the density distribution of the phosphor within the subject is determined, and optical tomographic information for forming an optical tomographic image of the subject is generated.

Due thereto, it suffices for the inverse problem computation, that uses a light diffusion equation for acquiring the optical tomographic information, to only be carried out with respect to the intensity of the fluorescence. Therefore, the processing load for generating the tomographic information is reduced, and the processing time can be shortened. Further, it suffices to carry out intensity measurement of light for forming the tomographic image, only with respect to the fluorescence that exits from the subject. Therefore, the device can be simplified and the measuring time can be shortened. For example, it is sufficient if the light-receiving heads 26 have the function of being able to measure only fluorescence, and there is no need for the light-receiving heads 26 to be able to measure the excitation light.

In contrast, in conventional structures, because the scattering coefficient D(r) and the absorption coefficient distribution μₐ(r) are not set as already-known values, the excitation light intensity distribution is needed as measurement data in addition to the fluorescence intensity distribution, and light-receiving heads that correspond to both fluorescence and excitation light are needed. Further, at this time, inverse problem computation is carried out with respect to the light diffusion equation for the excitation light and the light diffusion equation for the fluorescence, respectively, and the density distribution of the phosphor must be obtained. Accordingly, a device structure that processes the respective inverse problem computations is needed, and the device becomes large-scale.

In the above-described structure, the intensity of the fluorescence is detected at respective illumination positions, while the illumination positions of the excitation light onto the subject are changed by relatively moving the light source along the periphery of the subject. At this time, a structure can be used in which plural detecting units that detect the fluorescence are provided at a preset interval at the periphery of the subject, and the respective detecting units are moved as a counterpart to the relative movement of the light source with respect to the subject, and detect the intensity of the fluorescence.

The structure for detecting the intensity of the fluorescence at the optical tomographic image generating device can thereby be simplified.

In the above-described structure, the optical tomographic information generating device 100 relating to the present first exemplary embodiment uses the ART (Algebraic Reconstruction Technique) in the inverse problem at the time of computing the light intensity distribution, and carries out singular value decomposition with respect to the Jacobian matrix J that appears in the successive approximation formula of the ART so as to obtain the diagonal matrix D, and multiplies, by D, the unit diagonal matrix H in which the singular values in D that are less than or equal to the threshold value αth are replaced with 0, and thereby reduces the computational load of the inverse problem and realizes shortening of the processing time.

In the computation process that solves the inverse problem by the ART, the optical tomographic information generating device 100 decomposes the proportion of the change in the light intensity distribution with respect to the change in the optical characteristic value into plural independent elements, and from thereamong, specifies and removes the elements at which the effects of noise are dominant, and thereafter, solves the inverse problem. Due thereto, even in an environment that includes much noise, the inverse problem computation can be converged rapidly, and further, the accuracy of the reconstructed image can be improved. To further expound on this point, in the above-described computation, the elements at which noise is not dominant maintain their values as is, and therefore, the removal even of net signal components in the process of removing the effects of noise is prevented. From this standpoint as well, an improvement in the accuracy of the reconstructed image can be realized.

In the above-described structure, this introduction of the unit diagonal matrix H can simplify and facilitate calculation in a repeat approximation computation method such as the ART, and is linked to implementation in an actual device and ease of programming.

It is described that, in the above-described structure, the diagonal components whose singular values in D are less than or equal to the threshold value αth are replaced by 0 at the time of generating the unit diagonal matrix H from the diagonal matrix D. By setting an appropriate value for the threshold value αth, the accuracy of computing the light intensity distribution relating to the present exemplary embodiment, and accordingly, the accuracy of the reconstructed image obtained at the optical tomographic information generating device 100, can be improved even more. A concrete method of setting the threshold value αth is described hereinafter.

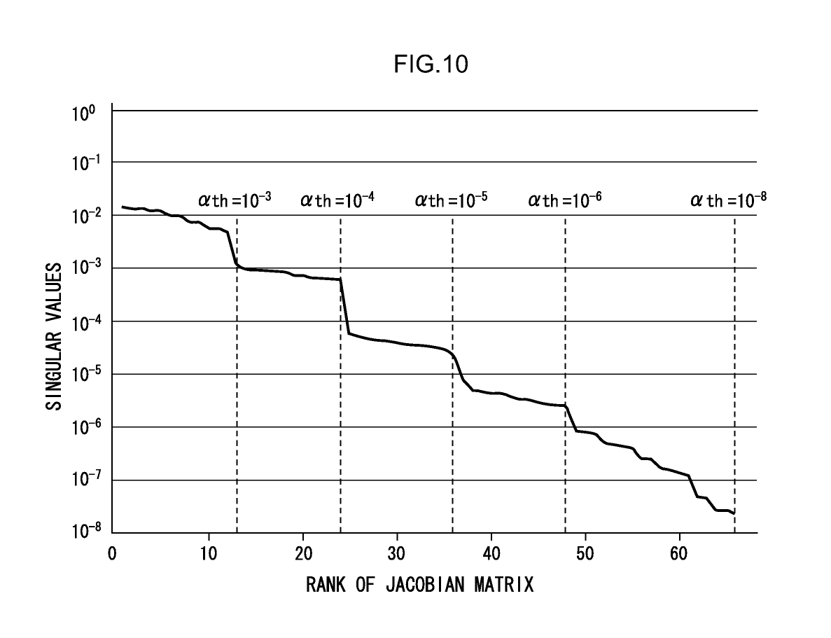

FIG. 10 is a diagram showing, as a characteristic curve, the relationship between the rank of the Jacobian matrix J (the horizontal axis) and the values of the singular values in the diagonal matrix D (the vertical axis). As can be understood from this drawing, the singular values in D have the property of decreasing in the form of steps as the rank of the Jacobian matrix increases.

The present inventors thought of using, as the threshold value αth that is used at the time of generating the unit diagonal matrix H from the diagonal matrix D, the values of the singular values at the places that change in this form of a step, i.e., places (shown by the dashed lines in the figure) where the singular values decrease suddenly as compared with other places. When singular values that are less than or equal to the threshold value αth are replaced by 0, there is the concern that, in the process of removing the effects of noise, signal components will be removed excessively such that even the net signal components are removed. Namely, there is a trade-off between removing the effects of noise and maintaining the net signal components. However, the present inventors noted that, if the places where the singular values suddenly vary are set to the threshold value αth, the possibility of being able to remove the effects of noise without excessively removing signal components increases. Concretely, the singular values vary in the form of a step in vicinities of the places where the singular values exhibit values of 10⁻³, 10⁻⁴, 10⁻⁵, 10⁻⁶. Thus, in the optical tomographic information generating device relating to the present exemplary embodiment, 10⁻³, 10⁻⁴, 10⁻⁵, 10⁻⁶ are used as the threshold value αth. Although the place where the singular values are 10⁻⁸ is, strictly speaking, not the form of a step, this value as well is additionally used as the threshold value αth for comparison with the other threshold values.

The characteristic curve shown in FIG. 10 varies in accordance with the computing environment and the system accuracy of the optical tomographic information generating device. Accordingly, the aforementioned concrete values of the threshold value αth are merely examples of the embodiment.

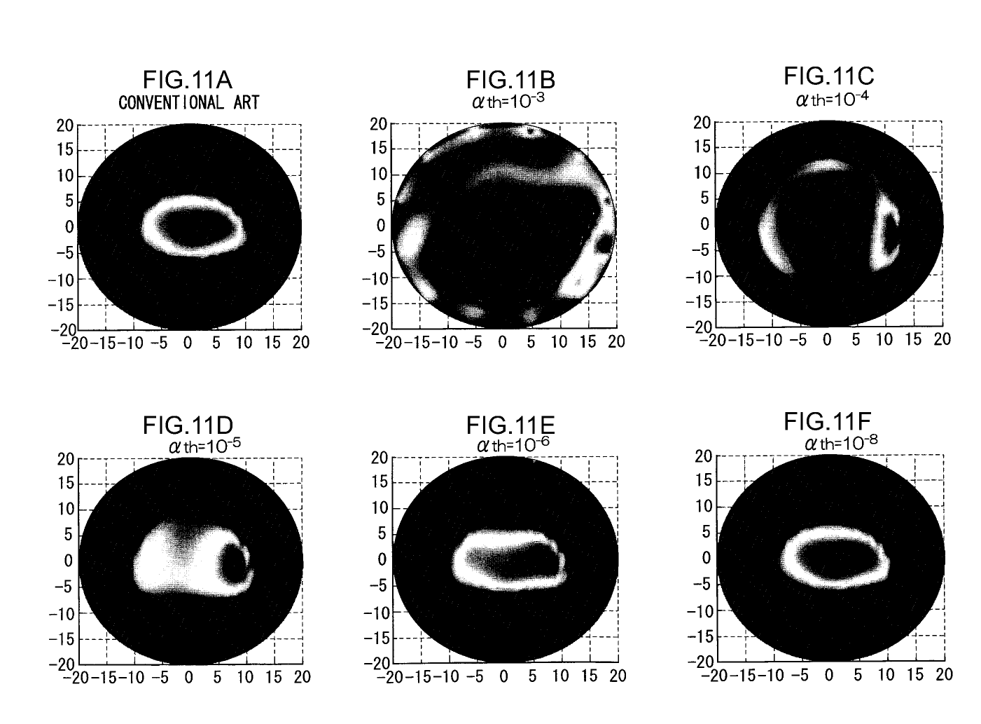

FIG. 11A through FIG. 11F are results verifying the accuracy of a reconstructed image by using an actual mouse to which antibodies have been administered. How the accuracy of the actual reconstructed image varies in cases in which the aforementioned values are used as the threshold value αth can be judged from these figures.

FIG. 11A is a case of the conventional ART, FIG. 11B is a case using 10⁻³ as the threshold value αth, FIG. 11C is a case using 10⁻⁴ as the threshold value αth, FIG. 11D is a case using 10⁻⁵ as the threshold value αth, FIG. 11E is a case using 10⁻⁶ as the threshold value αth, and FIG. 11F is a case using 10⁻⁸ as the threshold value αth. As can be understood from these drawings, in cases in which 10⁻⁴ or 10⁻⁵ is used as the threshold value αth, a reconstructed image of accuracy such that a region thought to be a tumor can be differentiated from other regions, can be obtained. Accordingly, 10⁻⁴ or 10⁻⁵ is used as the threshold value αth that is used by the optical tomographic information generating device relating to the present exemplary embodiment. It can be understood that, in a case of using 10⁻⁵ as the threshold value αth, not only is there accuracy such that the region thought to be a tumor can be identified as compared with other regions, but also, the size of the tumor as well can be reproduced with uniform accuracy. Accordingly, using 10⁻⁵ as the threshold value αth is more preferable.

In this way, in the optical tomographic information generating device relating to the present exemplary embodiment, values of plural places where the characteristic curve, that expresses the relationship between the rank of the Jacobian matrix J and the values of the singular values in the diagonal matrix D, varies in the form of a step are used as candidates for the threshold value αth that is used when generating the unit diagonal matrix H from the diagonal matrix D. Then, the optimal threshold value αth is appropriately selected from among the plural candidates for the threshold value αth. Due thereto, the accuracy of computing the light intensity distribution relating to the present exemplary embodiment, and accordingly, the accuracy of the reconstructed image obtained by the optical tomographic information generating device 100, can be improved even more.

The present exemplary embodiment describes, as an example, a case in which the value of a place where the characteristic curve, that expresses the relationship between the rank of the Jacobian matrix J and the values of the singular values in the diagonal matrix D, varies in the form of a step is used as the threshold value αth. However, the present invention is not limited to the same. For example, in a case in which it is desired to remove the effects of noise even more, a value, in which offset is added to the threshold value αth determined by the above-described setting method, may be used as the threshold value.

The present exemplary embodiment describes, as an example, a case in which, among the respective components of the Jacobian matrix that expresses the proportion of change in the light intensity distribution with respect to change in the optical characteristic value, the components at which the effects of noise can greatly appear are replaced with 0, i.e., a case in which these components are completely deleted. However, the present invention is not limited to the same. Because net signal components also ought to be included in these components, rather than completely deleting these components, they may be replaced by constants so as to be kept to magnitudes of a predetermined value or less in cases in which the reciprocals are determined. Due thereto, the accuracy of the reconstructed image can be improved while the computational load and the like are reduced.

### Second Exemplary Embodiment

The first exemplary embodiment describes, as an example, a form in which only the fluorescence emitted from the subject is actually measured, and the inverse problem of one system is solved. However, the present second exemplary embodiment describes a form in which not only the fluorescence emitted from the subject, but also the excitation light is measured, and inverse problems of two systems are solved.

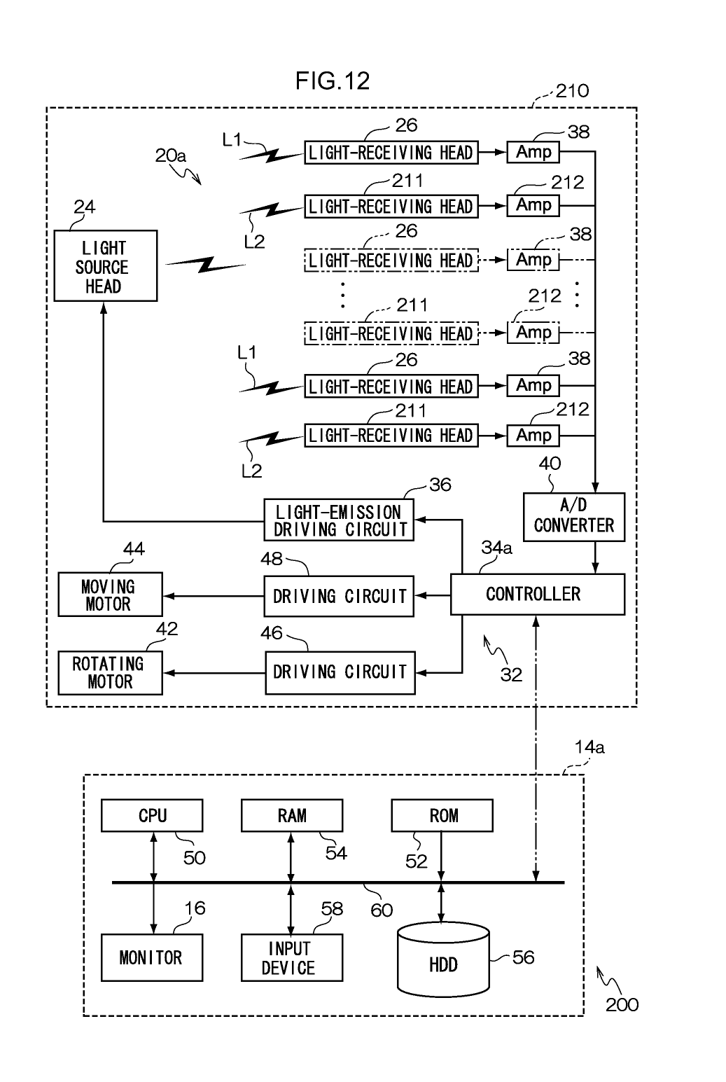

FIG. 12 is a block diagram showing the main structures of a measuring section 210 and an image processing section 14a within an optical tomographic information generating device 200 relating to the second exemplary embodiment of the present invention. Structural elements that are the same as those of the optical tomographic information generating device 100 shown in the first exemplary embodiment are denoted by the same reference numerals, and description thereof is omitted. Structural elements, whose basic operation is the same but that differ with regard to fine points, are denoted by a reference numeral in which a lower case letter is added to the same number, and explanation thereof is added appropriately. (The same method of notation is used in the following explanation of the figures as well.) For example, the image processing section 14a relating to the present second exemplary embodiment has the same basic structure as the image processing section 14 shown in the first exemplary embodiment, but because there are differences in the detailed operations thereof, the letter a is added to the same number 14.

In addition to the structures of the optical tomographic information generating device 100 shown in the first exemplary embodiment, the optical tomographic information generating device 200 further has light-receiving heads 211 and amplifiers (Amp) 212. The light-receiving heads 26 are light-receiving heads for fluorescence L1 as described in the first exemplary embodiment. The light-receiving heads 211 are light-receiving heads for excitation light L2. The amplifiers 212 are amplifiers for the light-receiving heads 211, and amplify the electric signals outputted from the light-receiving heads 211, and output the amplified signals to the A/D converter 40.

The paths from the light-receiving heads 211 to the A/D converter 40 are paths that are different from a first exemplary embodiment. The paths from the light-receiving heads 26 to the A/D converter 40 in the optical tomographic information generating device 100 are maintained as is in the optical tomographic information generating device 200 as well. Namely, the numbers of the light-receiving heads 26 and the amplifiers 38 in the optical tomographic information generating device 200 are the same numbers as those in the optical tomographic information generating device 100. The numbers of the light-receiving heads 211 for excitation light and the amplifiers 212 also are the same numbers as those of the light-receiving heads 26 for fluorescence and the amplifiers 38.

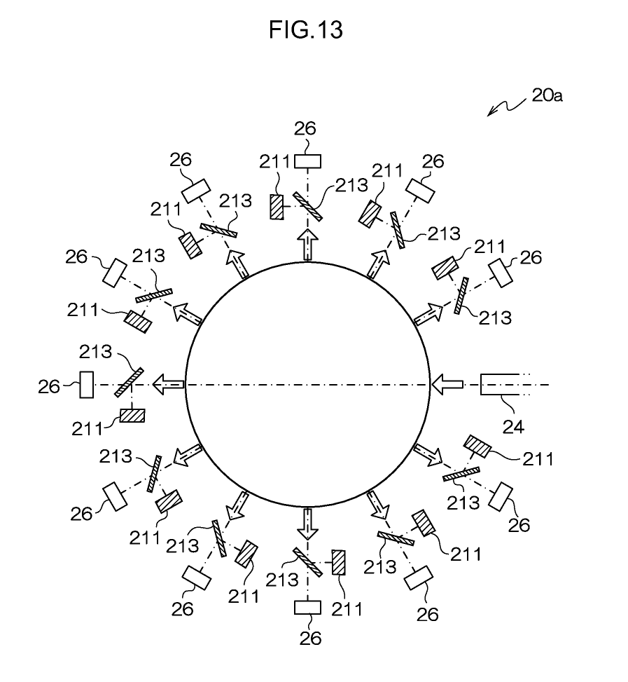

FIG. 13 is a drawing for explaining the relationship between the light-receiving heads 26 and the light-receiving heads 211, and the functions of the structures thereof.

As can be understood from FIG. 13, the basic structure of a measuring unit 20a of the optical tomographic information generating device 200 resembles that of the measuring unit 20 of the optical tomographic information generating device 100 relating to the first exemplary embodiment. However, on the path until the light exiting from the subject 18 reaches the light-receiving head 26, a dichroic mirror 213 is provided, and, among the light exiting from the subject 18, only a predetermined short wavelength component is reflected and is incident on the light-receiving head 211. The light that exits from the subject 18 includes not only a fluorescence L1 component, but also an excitation light L2 component. Here, the dichroic mirror 213 is structured so as to reflect only the excitation light L2 component that is a short wavelength as compared with the fluorescence L1, and only the excitation light L2 component is incident on the light-receiving head 211. Further, as described in the first exemplary embodiment, because an unillustrated excitation light cutting filter is provided at the front end of the light-receiving head 26, only the fluorescence L1 component enters into the light-receiving head 26.

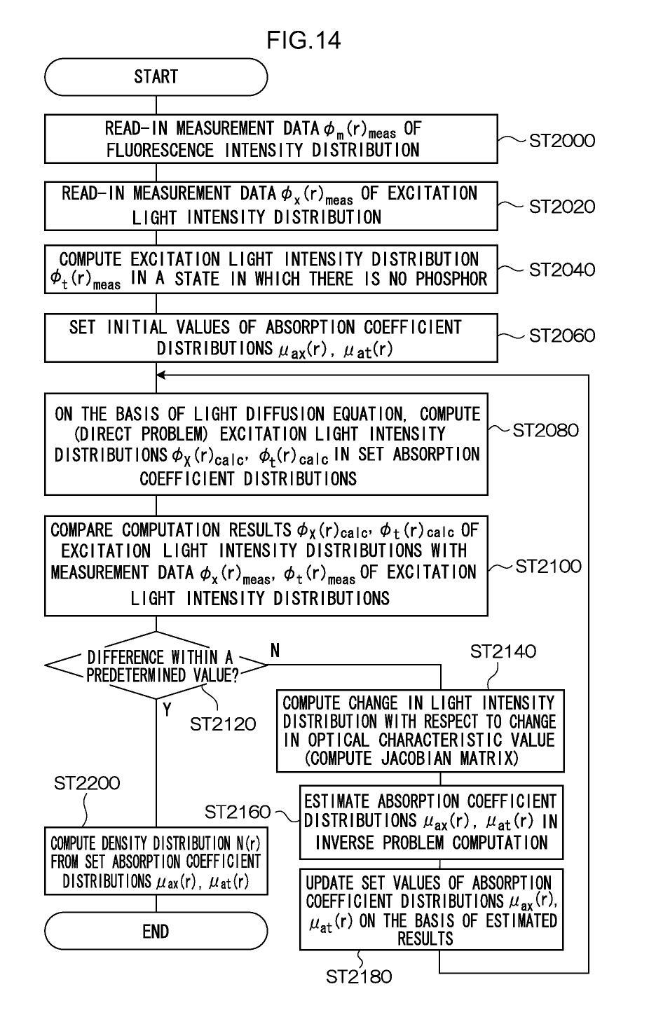

FIG. 14 is a flowchart showing the order of processings of density distribution computation of the phosphor 62 that is carried out by the image processing section 14a, i.e., the processes of a light intensity distribution computation method relating to the present exemplary embodiment.

As described above, only fluorescence is measured in the first exemplary embodiment, but in the present second exemplary embodiment, in addition to fluorescence, excitation light also is measured. In ST2000, measurement data Φₘ(r)ₘₑₐₛ of the fluorescence intensity distribution exiting from the subject 18 is read-in to the memory 51. In ST2020, measurement data Φₓ(r)ₘₑₐₛ of the excitation light intensity distribution exiting from the subject 18 also is read-in to the memory 51. Note that ST2000 is the same processing as ST1000 shown in FIG. 6 of the first exemplary embodiment.

In ST2040, excitation light intensity distribution Φₜ(r)ₘₑₐₛ in a case in which a phosphor does not exist is computed on the basis of following formula (20) from the fluorescence intensity distribution Φₘ(r)ₘₑₐₛ that has been read-in in ST2000 and the excitation light intensity distribution Φₓ(r)ₘₑₐₛ that has been read-in in ST2020.

[Expression 17]

Φₜ(r)ₘₑₐₛ=1/γΦₘ(r)ₘₑₐₛ+Φₓ(r)ₘₑₐₛ (20)

In ST2060, an initial value of absorption coefficient distribution μₐₓ(r) at the excitation light wavelength in a case in which a phosphor exists, and an initial value of absorption coefficient distribution μₐₜ(r) at the excitation light wavelength in a case in which a phosphor does not exist, are set as preparation for the loop computation from ST2080 onward. Note that, in the present exemplary embodiment as well, the diffusion coefficient distribution D(r) is an already known, substantially regular value in the same way as in the first exemplary embodiment.

In ST2080, due to the direct problem expressed by following light diffusion equation (21) being solved, excitation light intensity distribution Φₓ(r)_{calc} that exits from the subject 18 in a case in which a phosphor exists is determined. Further, due to the direct problem expressed by following light diffusion equation (22) being solved, excitation light intensity distribution Φₜ(r)_{calc} that exits from the subject 18 in a case in which a phosphor does not exist is determined.

[Expression 18]

{∇·D(r)∇−μₐₓ(r)}Φₓ(r)_{calc}=−qₛ(r) (21)

{∇·D(r)∇−μₐₜ(r)}Φₜ(r)_{calc}=−qₛ(r) (22)

In ST2100, Φₓ(r)_{calc}, that are the results of computation (predicted values) of the excitation light intensity distribution in a case in which a phosphor exists, and Φₓ(r)ₘₑₐₛ that are actually measured values are compared. Further, Φₜ(r)calc, that are the results of computation (predicted values) of the excitation light intensity distribution in a case in which a phosphor does not exist, and Φₜ(r)ₘₑₐₛ that are actually measured values are compared. Concretely, the differences between the respective predicted values and the respective actually measured values are determined as results of comparison.

The computations of ST2120 through ST2180 are a portion of loop computation that is similar to the first exemplary embodiment. Namely, in ST2120, it is judged whether the differences, determined in ST2100, between the respective predicted values and the respective actually measured values fall within an allowable range, and concretely, whether or not the differences are within a predetermined value that is set in advance. In a case in which it is judged that the differences are not within the predetermined value, there is loop computation that, after going through the calculations of ST2140 through ST2180, returns to ST2080. Here, the point that greatly differs from the first exemplary embodiment is the inverse problem computation that is carried out in ST2160. In the first exemplary embodiment, only the fluorescence that is emitted from the subject is actually measured, and the inverse problem of one system is solved. However, in the present second exemplary embodiment, not only the fluorescence, but also the excitation light that is emitted from the subject is measured, and inverse problems of two systems are solved.

Because there are two values of differences that are determined in ST2100, strictly speaking, the computations of ST2120 through ST2180 relating to the present second exemplary embodiment differ from the computations of ST1100 through ST1160 relating to the first exemplary embodiment. However, even though there are two differences, the gist of the repeated computation in the first exemplary embodiment that attempts to keep the difference within a predetermined value is similar in the present exemplary embodiment as well. Therefore, a person skilled in the art may appropriately determine how to prescribe the concrete method of repeated computation. In ST2120, in order to simplify explanation, explanation is given as if there were one difference. In ST2160 and ST2180, the parameter that is handled is the absorption coefficient distribution, which is different than the density distribution in the first exemplary embodiment. This is because the parameter, that is set in ST2060 as the initial value of the loop computation and that is updated in ST2180, is, differently than in the first exemplary embodiment, the absorption coefficient distribution.

When it is judged in ST2120 that the differences between the respective predicted values and the respective actually measured values are within a predetermined value, the routine moves on to ST2200. In ST2200, density distribution N(r) is computed in accordance with following formula (23) from the absorption coefficient distribution μₐₓ(r) and the absorption coefficient distribution μₐₜ(r) that has been finally set at this time, and the present flowchart ends. There are the relationships of following formulas (24) and (25) between the absorption coefficient distribution and the density distribution, and formula (23) is determined from these relationships.

[Expression 19]

N(r)={μₐₓ(r)−μₐₜ(t)}/ε (23)

μₐₓ(r)=μₐ(r)=εN(r) (24)

μₐₜ(r)=μₐ(r) (25)

As described above, in accordance with the optical tomographic information generating device 200 relating to the second exemplary embodiment of the present invention, not only the fluorescence that is emitted from the subject, but also the excitation light is measured, and inverse problems of two systems are solved. Therefore, the device structure becomes larger scale than that of the first exemplary embodiment, and the computational load increases as well. However, because the improved ART relating to the present invention is used, the computational accuracy of the light intensity distribution, and the accuracy of the reconstructed image obtained by the optical tomographic information generating device, can be improved.

The above-described respective exemplary embodiments relating to the present invention show examples of the present invention, and do not limit the structure of the present invention. The optical tomographic information generating device relating to the present invention is not limited to the above-described exemplary embodiments, and can be implemented by being changed in various ways within a scope that does not deviate from the object of the present invention.

For example, because the light diffusion equation can be similarly applied to lights other than fluorescence, the present invention is not limited to the optical tomographic information generating devices 100, 200, and may be an optical tomographic information generating device of an arbitrary structure that illuminates excitation light onto the subject 18, and detects light, other than fluorescence, that exits from the subject 18, and reconstructs a tomographic image on the basis of the intensity of that light. In the future, the optical tomographic information generating device and the like of the present invention may be applied to light that is naturally emitted without excitation light being illuminated.

The first exemplary embodiment describes, as an example, a case in which the light source head 24 and the light-receiving heads 26 mechanically rotate together with the frame 22. However, the first exemplary embodiment need not be limited to this structure in regard to the object thereof being processing an inverse problem in one system. For example, there may be a structure in which plural heads, that have both a light illuminating function and a light-receiving function, are disposed such that positions thereof are fixed, and during measurement, the heads may successively transition between the light illuminating function and the light-receiving function in a predetermined rotating direction and measure fluorescence or the like.

The second exemplary embodiment describes, as an example, a form in which the dichroic mirror 213 is provided and divides the fluorescence L1 component and the excitation light L2 component that exit from the subject 18, and these components are incident on the light-receiving head 26 for fluorescence and the light-receiving head 211 for excitation light, respectively. However, the second exemplary embodiment is not limited to the same, and may be structured such that, for example, the dichroic mirrors 213 are not provided, and effects of signal differences caused by differences in the light-receiving positions (angles) are reduced by disposing the light-receiving heads 26 and the light-receiving heads 211 alternately and more densely.

Fundamentally, the image that is the object of application of the present invention does not have to be a tomographic image. It suffices for the present invention to be a form that acquires a reconstructed image by solving an inverse problem that is based on a light diffusion equation.

Functions that are the same as those of the optical tomographic information generating device relating to the present invention may be realized by describing the algorithms of the light intensity distribution computing method relating to the present invention in a programming language, compiling them as needed, storing the light intensity distribution computing program in a memory (recording medium), and executing the program by an information processing unit of another optical tomographic information generating device.

The optical tomographic information generating device, the light intensity distribution computing method, and the light intensity distribution computing program relating to the present invention can be used in applications such as, for example, devices that are adapted to acquire an optical tomographic image by using the distribution information of a light-emitting body that emits light due to excitation light, and in particular, fluorescence tomography devices.

Embodiments of the present invention are described above, but the present invention is not limited to the embodiments as will be clear to those skilled in the art.

What is claimed is:

1. An optical tomographic information generating device that, on the basis of a light diffusion equation, determines a computed value of an intensity distribution of light exiting from a subject, and, in accordance with a difference between the computed value and an actually measured value, carries out recomputation that uses ART (Algebraic Reconstruction Technique) and acquires an updated value of the computed value, and generates optical tomographic information of the subject by using the updated value, the device comprising:
a Jacobian matrix computing unit that computes, from an optical characteristic value of the subject, a Jacobian matrix that expresses a proportion of change in the light intensity distribution with respect to change in the optical characteristic value;
a singular value decomposing unit that singular-value-decomposes the Jacobian matrix, and acquires a diagonal matrix;
a unit diagonal matrix acquiring unit that acquires a unit diagonal matrix in which diagonal components, that are less than or equal to a threshold value, of the diagonal matrix are replaced by 0; and
a successive approximation unit that, in recomputation using the ART, carries out approximation by carrying out substitution, that uses the unit diagonal matrix, with respect to a difference between an actually measured value and the computed value that appears in a successive approximation formula of the ART, and acquires the updated value.

2. The optical tomographic information generating device of claim 1, wherein
the Jacobian matrix computing unit computes a Jacobian matrix J from an optical characteristic value of the subject,
the singular value decomposing unit singular-value-decomposes the Jacobian matrix J as J=UDV^{T}, and acquires diagonal matrix D,
the unit diagonal matrix acquiring unit replaces diagonal components, that are less than or equal to a threshold value, of the diagonal matrix D with 0, and acquires a unit diagonal matrix H, and
the successive approximation unit carries out approximation by carrying out substitution that makes a difference Δy, between an actually measured value and the computed value that appears in the successive approximation formula of the ART, be UHU^{T}Δy.

3. The optical tomographic information generating device of claim 2, wherein the unit diagonal matrix acquiring unit uses, as the threshold value, a singular value of a position that changes in a form of a step in a characteristic curve that expresses change in singular values with respect to change in a rank of the Jacobian matrix.

4. A light intensity distribution computing method that, on the basis of a light diffusion equation, determines a computed value of an intensity distribution of light exiting from a subject, and, in accordance with a difference between the computed value and an actually measured value, carries out recomputation that uses ART and updates the computed value, the method comprising:
computing, from an optical characteristic value of the subject, a Jacobian matrix that expresses a proportion of change in the light intensity distribution with respect to change in the optical characteristic value;
singular-value-decomposing the Jacobian matrix, and obtaining a diagonal matrix;
acquiring a unit diagonal matrix in which diagonal components, that are less than or equal to a threshold value, of the diagonal matrix are replaced by 0; and
in recomputation using the ART, carrying out approximation by carrying out substitution, that uses the unit diagonal matrix, with respect to a difference between an actually measured value and the computed value that appears in a successive approximation formula of the ART, and obtaining an updated value of the computed value.

5. A computer readable non-transitory medium storing a light intensity distribution computing program that causes a computer to execute a light intensity distribution computing processing that, on the basis of a light diffusion equation, determines a computed value of an intensity distribution of light exiting from a subject, and, in accordance with a difference between the computed value and an actually measured value, carries out recomputation that uses ART and updates the computed value, the processing comprising:
computing, from an optical characteristic value of the subject, a Jacobian matrix that expresses a proportion of change in the light intensity distribution with respect to change in the optical characteristic value;
singular-value-decomposing the Jacobian matrix, and obtaining a diagonal matrix;
acquiring a unit diagonal matrix in which diagonal components, that are less than or equal to a threshold value, of the diagonal matrix are replaced by 0; and
in recomputation using the ART, carrying out approximation by carrying out substitution, that uses the unit diagonal matrix, with respect to a difference between an actually measured value and the computed value that appears in a successive approximation formula of the ART, and acquiring an updated value of the computed value.
